(19) United States
(12) Patent Application Publication
(10) Pub. No.: US 2025/0105661 A1
(43) Pub. Date: Mar. 27, 2025

(54) REDUNDANT POWER SUPPLY SYSTEM

(71) Applicant: TOYOTA JIDOSHA KABUSHIKI KAISHA, Toyota-shi (JP)

(72) Inventor: Kazutoshi INOUE, Nagakute-shi (JP)

(73) Assignee: TOYOTA JIDOSHA KABUSHIKI KAISHA, Toyota-shi (JP)

(21) Appl. No.: 18/758,393

(22) Filed: Jun. 28, 2024

(30) Foreign Application Priority Data
Sep. 26, 2023 (JP) 2023-163046

(51) Int. Cl. H02J 9/06; H02J 7/34

(52) U.S. Cl. CPC H02J 9/068; H02J 7/342; H02J 9/061; H02J 2207/20

(57) ABSTRACT

A redundant power supply system connected to a load system to which power is supplied from a main power supply, comprising: a redundant power supply redundantly provided to the main power supply; a first semiconductor relay connecting the redundant power supply and the load system so that backup power supply from the redundant power supply to the load system can be supplied; and a second semiconductor relay connecting the main power supply and the redundant power supply so that the redundant power supply can be charged by the main power supply, wherein the second semiconductor relay remains electrically conductive while power supply from the main power supply to the load system is normal.

### CROSS-REFERENCE TO RELATED APPLICATION

This application claims priority to Japanese Patent Application No. 2023-163046 filed on Sep. 26, 2023, incorporated herein by reference in its entirety.

### BACKGROUND

### 1. Technical Field

The present disclosure relates to redundant power supply systems that are mounted on vehicles etc.

### 2. Description of Related Art

Japanese Unexamined Patent Application Publication No. 2021-040475 (JP 2021-040475 A) discloses a power supply system using a so-called redundant configuration in which electric power is supplied from a main power supply (primary power supply) to a load via a main system bus and electric power is supplied from a sub-power supply (redundant power supply) to a load via a sub-system bus.

### SUMMARY

In a power supply system including a main power supply and a redundant power supply as power supply sources to loads, the timing at which a load system including the loads is started may be different from the timing at which a redundant power supply system including the redundant power supply is started. In this case, an incorrect diagnosis may occur due to the difference between the start timings. Such an incorrect diagnosis is also referred to as misdiagnosis.

The present disclosure was made in view of the above problem, and it is an object of the present disclosure to provide a redundant power supply system that can reduce or prevent misdiagnosis due to the difference between the start timing of a load system and the start timing of the redundant power supply system.

In order to solve the above problem, an aspect of the technique of the present disclosure is a redundant power supply system connected to a load system to which electric power is supplied from a main power supply. The redundant power supply system includes: a redundant power supply that is redundant to the main power supply; a first semiconductor relay connecting the redundant power supply and the load system so as to allow backup power supply from the redundant power supply to the load system; and a second semiconductor relay connecting the main power supply and the redundant power supply so as to allow charging of the redundant power supply by the main power supply. The second semiconductor relay remains electrically conductive while power supply from the main power supply to the load system is normal.

In the redundant power supply system of the present disclosure, the second semiconductor relay is electrically conductive while the power supply from the main power supply to the load system is normal. Therefore, a reverse current flow from the load system to the redundant power supply system can be avoided even when the load system is started before the redundant power supply system. As a result, misdiagnosis of an abnormality (such as ground fault) in the load system due to the reverse current can be reduced or prevented.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating a connection state between a redundant power supply system and a load system according to an embodiment of the present disclosure; and

FIG. 2 is a process flow chart for explaining control by the power supply system of the vehicle.

### DETAILED DESCRIPTION OF EMBODIMENTS

In the redundant power supply system of the present disclosure, when there is no problem in power supply from the main power supply to the load system, a semiconductor relay for disconnecting the main power supply from the redundant power supply in the event of an abnormality is always kept electrically conductive by a hard configuration such as a latch circuit. Thus, when the power supply is normal, the potential on the redundant power supply side of the semiconductor relay for supplying power from the redundant power supply to the load system can always be maintained higher than the potential on the opposite side. Therefore, even when the start-up of the load system becomes faster than the start-up of the redundant power supply system, the current does not flow back from the load system to the redundant power supply system. Therefore, it is possible to reduce or prevent misdiagnosis of a ground fault of the load system etc. Hereinafter, an embodiment of the present disclosure will be described in detail with reference to the drawings.

### Embodiment

### Configuration

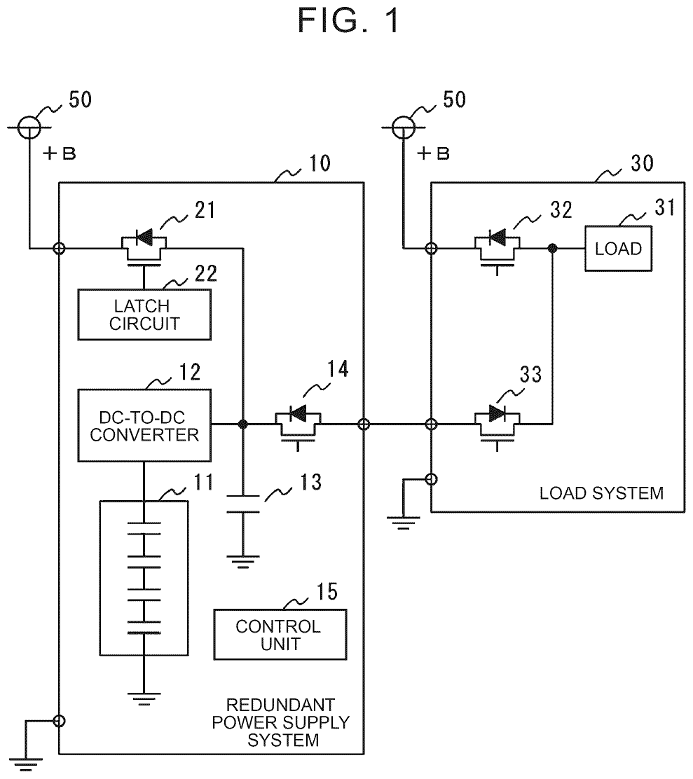

FIG. 1 is a schematic configuration diagram illustrating a connection state between a redundant power supply system 10 and a load system 30 according to an embodiment of the present disclosure. In FIG. 1, the redundant power supply system 10 and the load system 30 are connected to the main power supply 50 so that power can be received. In addition, the redundant power supply system 10 is connected to the load system 30 so that backup power supply can be performed.

The redundant power supply system 10 according to the present embodiment can be mounted on a vehicle or the like equipped with a load system 30 (brake, steering, shift-by-wire, or the like) that requires a redundant power supply configuration. Hereinafter, the redundant power supply system 10 will be described with reference to an example in which the redundant power supply system 10 is mounted in a power supply system of a vehicle.

The main power supply 50 is a main power supply that supplies power necessary for the operation of the load system 30. The main power supply 50 is a power supply for supplying power for charging a redundant power supply, which will be described later, to the redundant power supply system 10. The main power supply 50 can be a power supply that is always supplied with +B voltage regardless of the ignition state in the vehicle.

The redundant power supply system 10 is a system for backing up power to the load system 30 in place of the main power supply 50 when an abnormality occurs in the power supply from the main power supply 50 to the load system 30 due to a power failure or the like. The redundant power supply system 10 is activated when the ignition of the vehicle is turned on (IGR-ON).

The redundant power supply system 10 includes a redundant power supply 11, a DCDC converter 12, a capacitor 13, a first semiconductor relay 14, a control unit 15, a second semiconductor relay 21, and a latch circuit 22.

The redundant power supply 11 is, for example, a power storage element such as a capacitor or a secondary battery (such as a lithium-ion battery) configured to be chargeable and dischargeable. The redundant power supply 11 is connected to DCDC converters 12 so as to be chargeable and dischargeable.

DCDC converter 12 is a power converter for converting the inputted power into a predetermined-voltage power and outputting the converted power. DCDC converters 12 can charge the power supplied from the main power supply 50 via the second semiconductor relay 21 to the redundant power supply 11 based on an instruction (voltage command value or the like) from the control unit 15. In addition, DCDC converters 12 can supply the electric power (backup power) stored in the redundant power supply 11 to the load system 30 via the first semiconductor relay 14 based on an instruction from the control unit 15.

The capacitor 13 is an electrolytic capacitor provided at the output-side of DCDC converter 12 in order to cope with the transient current dissipation in the event of a power failure.

The first semiconductor relay 14 is, for example, a switching device using a field-effect transistor (FET) The first semiconductor relay 14 is inserted between DCDC converter 12 and the load system 30 in a direction in which a body diode (parasitic diode) rectifies from the load system 30 to DCDC converter 12. The first semiconductor relay 14 switches between electrical conduction and interruption based on an instruction from the control unit 15.

The control unit 15 is configured to control charging and discharging of the redundant power supply 11 by instructing DCDC converters 12 to perform operations (e.g., voltage-command values). In addition, the control unit 15 controls the state of conduction and interruption of the first semiconductor relay 14. The control unit 15 includes, for example, a microcomputer including a processor, a memory, an input/output interface, and the like, and realizes a predetermined function by the processor reading and executing a program stored in the memory.

The second semiconductor relay 21 is, for example, a switch element using a field-effect transistor. The second semiconductor relay 21 is inserted between the main power supply 50 and DCDC converter 12 in a direction in which the body diode rectifies from DCDC converter 12 to the main power supply 50. The second semiconductor relay 21 switches the state of electrical conduction and interruption based on the hard control by the latch circuit 22.

The latch circuit 22 is an electric circuit capable of holding the second semiconductor relay 21 in a state of either conduction or interruption, regardless of whether the redundant power supply system 10 is activated or not. As the mechanism of the latch circuit 22, the following mechanism can be exemplified. The illustrated arrangement connects the output of the comparator, which receives the voltage of the main power supply 50 and the predetermined reference voltage, to the gate terminal of the second semiconductor relay 21 (FET). Further, in the illustrated mechanism, when the voltage of the main power supply 50 is higher than the predetermined reference voltage, a high level is output from the comparator to fix the second semiconductor relay 21 in the ON state. Further, the illustrated mechanism outputs a low level from the comparator to fix the second semiconductor relay 21 in the off state when the voltage of the main power supply 50 is lower than a predetermined reference voltage. The reference voltage is a voltage that can be sufficiently exceeded by the main power supply 50 in a normal state. In addition to this mechanism, a known mechanism can be used as the latch circuit 22.

The load system 30 is equipment of a vehicle that operates with electric power of the main power supply 50, and is a system that requires a backup operation using the redundant power supply 11 in an emergency. Examples of the load system 30 include brakes, steering, shift-by-wire, and the like. The load system 30 includes a load 31 and semiconductor relays 32 and 33.

The load 31 is actuators (ACT), electronic control units (ECU), and the like required for realizing the system-based operation. Semiconductor relays 32 and 33 are switch elements provided to perform fault diagnosis when load system 30 is activated. The semiconductor relays 32 and 33 are controlled to be on/off in the fault diagnosis. In the fault diagnosis, whether or not the load 31 operates normally, whether or not the semiconductor relays 32 and 33 can operate normally, and the like are diagnosed. As an example, the fault diagnosis of the load system 30 is performed at a timing at which a door (such as a driver's seat side door) of a vehicle that is in front of the ignition of the vehicle in the on-state (IGR-ON) is opened.

### Control

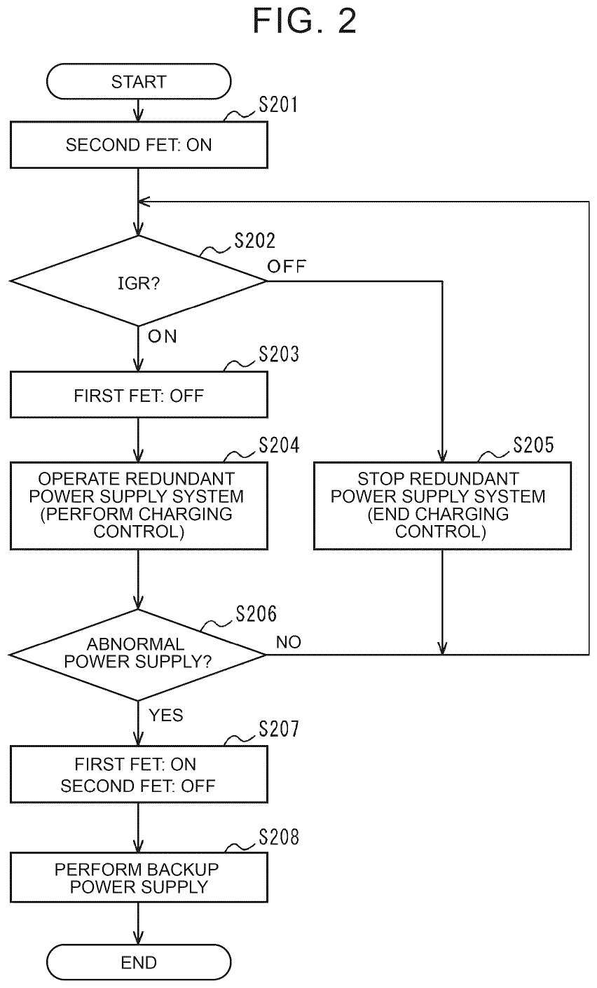

Next, with further reference to FIG. 2, the control executed in the vehicle equipped with the redundant power supply system 10 according to the present embodiment will be described. FIG. 2 is a processing flowchart for explaining control by the power supply system of the vehicle.

The control illustrated in FIG. 2 is initiated by the main power supply 50 first being connected (normal state) to the redundant power supply system 10. The control illustrated in FIG. 2 is repeatedly performed until an abnormality occurs in the power supply of the main power supply 50 and backup power supply to the load system 30 is performed by the redundant power supply 11 (abnormal state).

### S201

In the redundant power supply system 10, the second semiconductor relay 21 (second FET) is controlled to be in the on-state (ON) by the latch circuit 22. The ON state of the second semiconductor relay 21 is maintained in hardware regardless of the state of activation/deactivation of the redundant power supply system 10. By this control, the +B voltage of the main power supply 50 is constantly applied to DCDC converters 12 of the first semiconductor relay 14 (first FET) (+B pass-through). When the second semiconductor relay 21 is controlled to be in the on-state, the process proceeds to S202.

### S202

A determination is made as to whether the ignition status of the vehicle is on-state (IGR-ON) or off-state (IGR-OFF). If the ignition is on (S202, ON), the process proceeds to S203. On the other hand, when the ignition is in the off-state (S202, OFF), the process proceeds to S205.

### S203

The redundant power supply system 10 is activated by ignition-on (IGR-ON) of the vehicle, and controls the first semiconductor relay 14 (first FET) to be in an off-state (OFF) via an instruction from the control unit 15. When the redundant power supply system 10 is already activated and operating, the operating state is maintained. When the first semiconductor relay 14 is controlled to be in the off-state, the process proceeds to S204.

### S204

The redundant power supply system 10 operates DCDC converters 12, and performs charge control, which is control for charging the redundant power supply 11 to a predetermined amount of electric power storage (electric power required for backup) by using the electric power of the main power supply 50 supplied via the second semiconductor relay 21. When the charge control of the redundant power supply 11 is performed, the process proceeds to S206.

### S205

When the system is operating, the redundant power supply system 10 terminates the charge control of the redundant power supply 11 and stops the system. When the redundant power supply system 10 is not operating, the system does not start up. When the charge control of the redundant power supply 11 is completed, the process proceeds to S206.

### S206

The redundant power supply system 10 determines whether an abnormality has occurred in the power supply from the main power supply 50 to the load system 30. The occurrence of the abnormality can be determined by monitoring the output voltage and the output current of the main power supply 50. If it is determined that an abnormality has occurred in power supply (S206, Yes), the process proceeds to S207. On the other hand, if it is determined that no abnormality has occurred in power supply (S206, No), the process proceeds to S202.

### S207

The redundant power supply system 10 controls the first semiconductor relay 14 (first FET) to be in the on-state (ON) via an instruction from the control unit 15. In the redundant power supply system 10, the second semiconductor relay 21 (second FET) is controlled to be in the off-state (OFF) by the latch circuit 22. The off state of the second semiconductor relay 21 is maintained in hardware regardless of the state of activation/deactivation of the redundant power supply system 10. When the states of the first semiconductor relay 14 and the state of the second semiconductor relay 21 are respectively controlled, the process proceeds to S208.

### S208

The redundant power supply system 10 performs backup power supply that supplies power of the redundant power supply 11 to the load system 30. This backup power supply is performed, for example, until a predetermined evacuation action by the load system 30 is completed. When the backup power supply by the redundant power supply system 10 is performed, this control ends.

It is preferable that information provision (such as a warning display) for notifying that an abnormality has occurred in the power supply system is performed for a user of the vehicle or the like in association with the completion of the present control.

### Operations and Effects

As described above, the redundant power supply system 10 according to the embodiment of the present disclosure includes the redundant power supply 11, the first semiconductor relay 14, and the second semiconductor relay 21. The redundant power supply 11 is provided redundantly with respect to the main power supply 50 that supplies power to the load system 30. The first semiconductor relay 14 connects the redundant power supply 11 (and DCDC converters 12) and the load system 30 so that backup power can be supplied from the redundant power supply 11 to the load system 30. The second semiconductor relay 21 connects the main power supply 50 and the redundant power supply 11 (and DCDC converters 12) so that the redundant power supply 11 can be charged by the main power supply 50. The second semiconductor relay 21 remains electrically conductive by the hard control of the latch circuit 22 while the power supply from the main power supply 50 to the load system 30 is normal (+B pass-through).

By this control, when the power supply from the main power supply 50 to the load system 30 is normal, the potential of the first semiconductor relay 14 on the side of the redundant power supply 11 can always be maintained higher than the potential of the load system 30. The start-up timing of the load system 30 may be earlier than the start-up timing of the redundant power supply system 10. Even in such a case, by the above-described control, the current does not flow back from the load system 30 to the redundant power supply system 10 through the body diode of the first semiconductor relay 14. Therefore, it is possible to reduce or prevent misdiagnosis such as determining that the capacitor 13 is charged due to the circulation of the current as a ground fault of the load system 30.

Further, according to the redundant power supply system 10 of the present embodiment, the second semiconductor relay 21 is kept electrically conductive by the hard control of the latch circuit 22. For this reason, for example, it is unnecessary to notify the activation of the load system 30 by a direct wire or the like, and to perform control such that the activation timing of the redundant power supply system 10 is adjusted to the activation timing of the load system 30. Therefore, it is possible to suppress an increase in system cost and a change in control logic.

Although an embodiment of the present disclosure has been described above, the present disclosure can be regarded as a redundant power supply system and a control method executed by a redundant power supply system including a processor and a memory. Further, the present disclosure can be regarded as a vehicle equipped with a control program for executing the control method, a computer-readable non-transitory storage medium storing the control program, and a redundant power supply system.

The redundant power supply system of the present disclosure can be used for a vehicle equipped with a load that requires a redundant power supply configuration.

What is claimed is:

1. A redundant power supply system connected to a load system to which electric power is supplied from a main power supply, the redundant power supply system comprising:
a redundant power supply that is redundant to the main power supply;
a first semiconductor relay connecting the redundant power supply and the load system so as to allow backup power supply from the redundant power supply to the load system; and
a second semiconductor relay connecting the main power supply and the redundant power supply so as to allow charging of the redundant power supply by the main power supply, wherein
the second semiconductor relay remains electrically conductive while power supply from the main power supply to the load system is normal.

2. The redundant power supply system according to claim 1, wherein the second semiconductor relay includes
a field effect transistor inserted between the redundant power supply and the load system, and
a latch circuit configured to hold the field effect transistor on when a voltage of the main power supply is equal to or higher than a predetermined reference voltage.

3. The redundant power supply system according to claim 2, wherein:
the latch circuit holds the field effect transistor off when the voltage of the main power supply is lower than the predetermined reference voltage; and
the first semiconductor relay is controlled to be electrically conductive based on occurrence of an abnormality in the power supply from the main power supply.
